(19) United States
(12) Patent Application Publication
(10) Pub. No.: US 2026/0292766 A1
(43) Pub. Date: Sep. 24, 2026

(54) METHODS FOR VERIFYING CHANNEL STATUS

(71) Applicant: InterDigital Patent Holdings, Inc., Wilmington, DE (US)

(72) Inventors: Fumihiro HASEGAWA, Westmount (CA); Yugeswar Deenoo NARAYANAN THANGARAJ, Chalfont, PA (US); Ognen OGNENOSKI, London (GB); Remun KOIRALA, London (GB); Moon IL LEE, Melville, NY (US); Frank LASITA, Southport, NC (US); Shahab HAMIDI-RAD, Sunnyvale, CA (US)

(73) Assignee: InterDigital Patent Holdings, Inc., Wilmington, DE (US)

(21) Appl. No.: 19/472,512

(22) PCT Filed: Apr. 4, 2024
(86) PCT No.: PCT/US2024/023069

§ 371 Date: Oct. 3, 2025

Related U.S. Application Data
(60) Provisional application No. 63/457,002, filed on Apr. 4, 2023.

(51) Int. Cl. H04W 64/00; H04L 5/00; H04L 41/16

(52) U.S. Cl. CPC H04W 64/00; H04L 5/0051; H04L 41/16

(57) ABSTRACT

A line of sight (LOS) indicator verification is performed by a wireless transmit receive unit (WTRU) for a target transmit receive point (TRP) that transmits positioning reference signals (PRSs). The WTRU receives a request to verify a LOS indicator and a SRS resource ID and receives a PRS from a transmit receive point (TRP). The WTRU measures characteristics of the PRS and determining an associated LOS indicator and compares the determined LOS indicator to the configured threshold. The WTRU transmits a sounding reference signal for positioning (SRSp) associated with the SRS resource ID within the configured time window from receiving the PRS, when the determined LOS indicator is below the configured threshold. Additional embodiments are disclosed.

### CROSS-REFERENCE TO RELATED APPLICATIONS

This application claims the benefit of U.S. Provisional Application No. 63/457,002, filed Apr. 4, 2023, the contents of which are incorporated herein by reference.

### BACKGROUND

Radio based positioning may use data-driven methods such as machine learning algorithms where a training data set with positioned measurements are used to train a model that transforms measurements to position. Data should be separated into line-of-sight (LOS) and non-LOS (NLOS) data before the training of the machine learning algorithms to achieve good positioning performance under both LOS and NLOS conditions. Current wireless networks may use LOS indicators in positioning methods. For example, a LOS indicator per transmit receive point (TRP), or per positioning reference signal (PRS) resource may be used in downlink to a client device, such as a wireless transmit receive unit (WTRU), to support downlink-based positioning methods. In the uplink, the WTRU can also indicate a LOS indicator per TRP or per positioning reference signal (PRS) resource to the network (e.g., a location management function (LMF), gNB, etc.). Artificial intelligence machine learning (AIML) models may be trained to generate LOS indicators as labels or estimates based on inputs (e.g., measurements). LOS indicators can be generated by the WTRU or network although a quality of the LOS indicator is not currently verified by the WTRU or network. Thus, when the network or the WTRU trains an AIML model by setting the LOS indicator, generated by the WTRU or network, as the desired target, and if the LOS indicator is not verified, the output (e.g., inference) of the AIML model (e.g., inferred LOS indicators) may not be reliable. Thus a need exists to increase reliability of the LOS indicators and AIML models using LOS indicators should further be improved.

### SUMMARY

Aspects of the embodiments may relate to AIML positioning and measurement procedures for wireless networks. A WTRU receives configuration information for line of sight (LOS) indicator verification including a threshold, an associated time window and one or more sounding reference signal for positioning (SRSp). In one example of an uplink (UL) transmission procedure, the WTRU determines a line of sight (LOS) indicator for the target transmit receive point (TRP), for example a gNB or a location management function (LMF), based on measurements made on received positioning reference signals (PRSs). In one aspect, the WTRU determines to transmit a configured sounding reference signal for positioning (SRSp) to the network if at least one condition to initiate a LOS verification procedure (e.g., the determined LOS indicator is below a configured threshold) is satisfied. LOS indicators may therefore be verified for use in AIML modeling. Additional aspects are disclosed.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 is a diagram of an example 3-layer neural network;

FIG. 3 is a functional diagram illustrating examples of line of sight (LOS) indicator associated with a transmit receive point (TRP) and LOS indicators associated with positioning reference signals (PRSs);

FIG. 4 is a diagram showing example scenarios of PRS and SRS transmission directions;

FIG. 5 is a positional diagram showing TRP and WTRU transmission perspective angles;

FIG. 6 is a functional diagram showing potential different transmit (Tx) and receive (Rx) angles in PRS transmission between a TRP and WTRU;

FIG. 7 is a directional diagram showing spatially adjacent SRS transmissions from a WTRU;

FIG. 8 is a functional diagram showing an example of three sets of positioning reference signals (PRS) reception and sounding reference signal for positioning (SRSp) transmission;

FIG. 9 is a functional diagram showing an example of SRS transmission after reception of PRS;

FIG. 10 is a spatial diagram showing relationship between SRS and channel state information (CSI) reference signal (RS) in on example;

FIG. 11 is a functional diagram showing examples of multiple SRSs spatially related to PRS transmission;

FIG. 12 is a timing diagram showing an example time limit to transmit a SRS after receiving a PRS;

FIG. 13 is a flow diagram of one method of verifying LOS indicators according to an embodiment; and

FIG. 14 is a flow diagram of another method of verifying LOS indicators of an embodiment.

### DETAILED DESCRIPTION

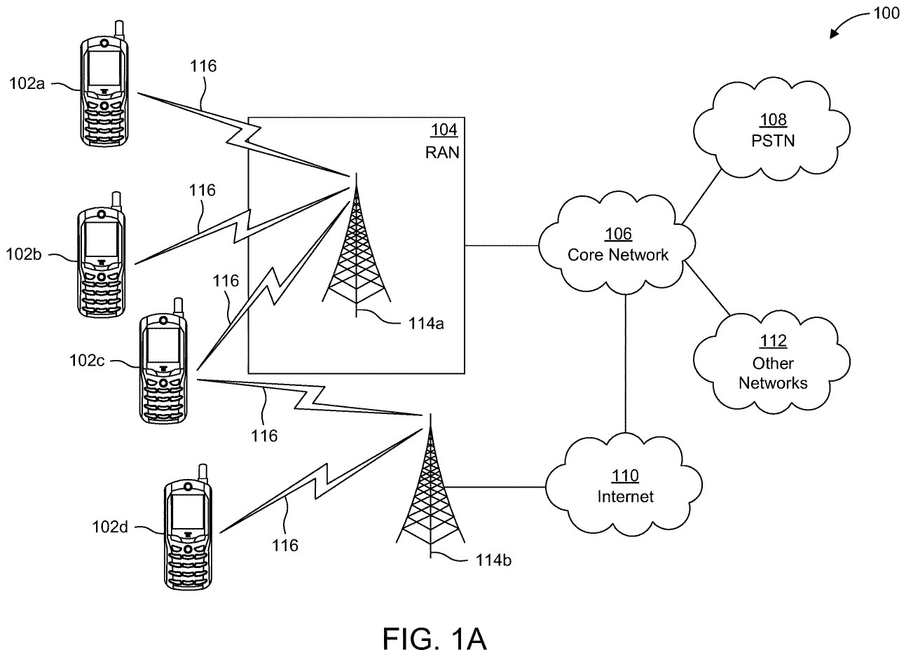

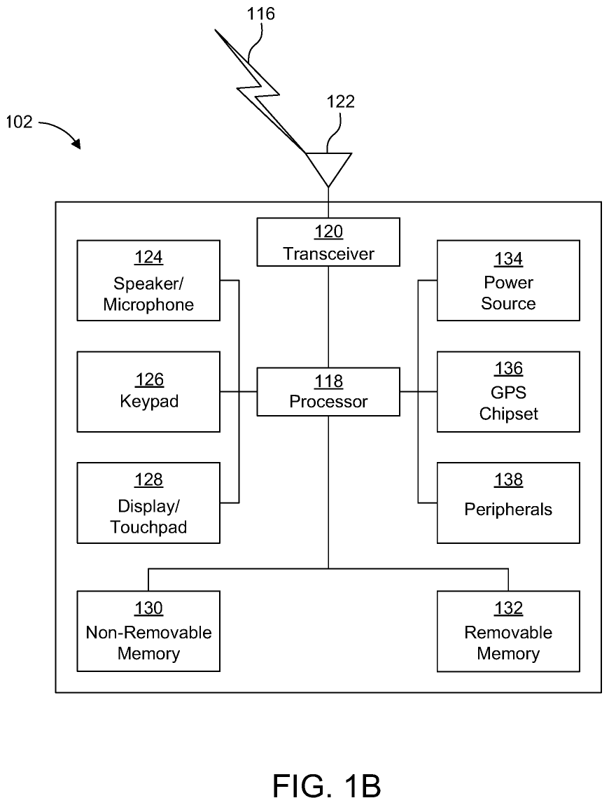

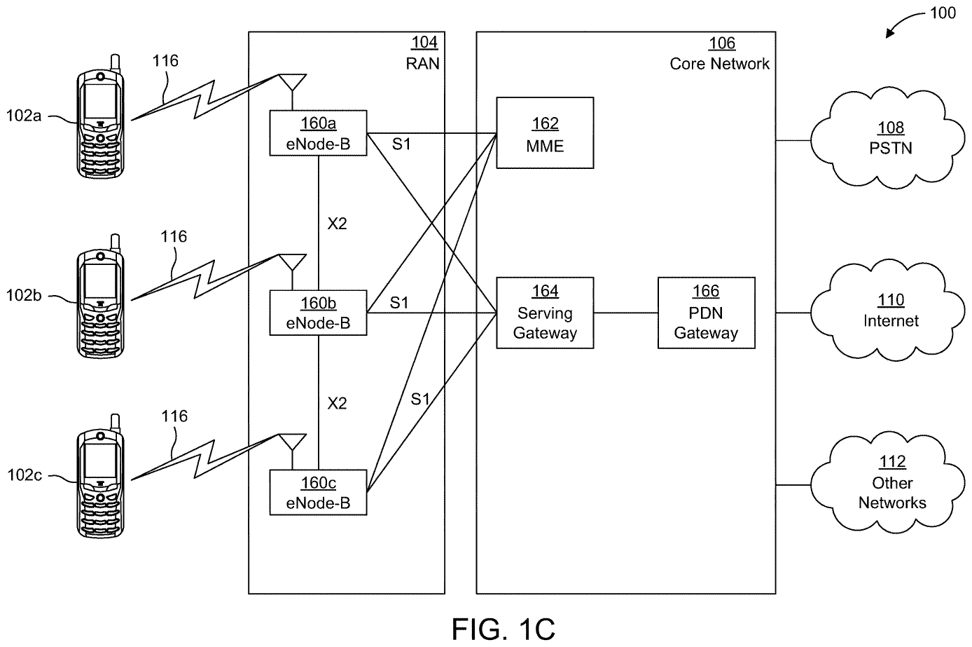

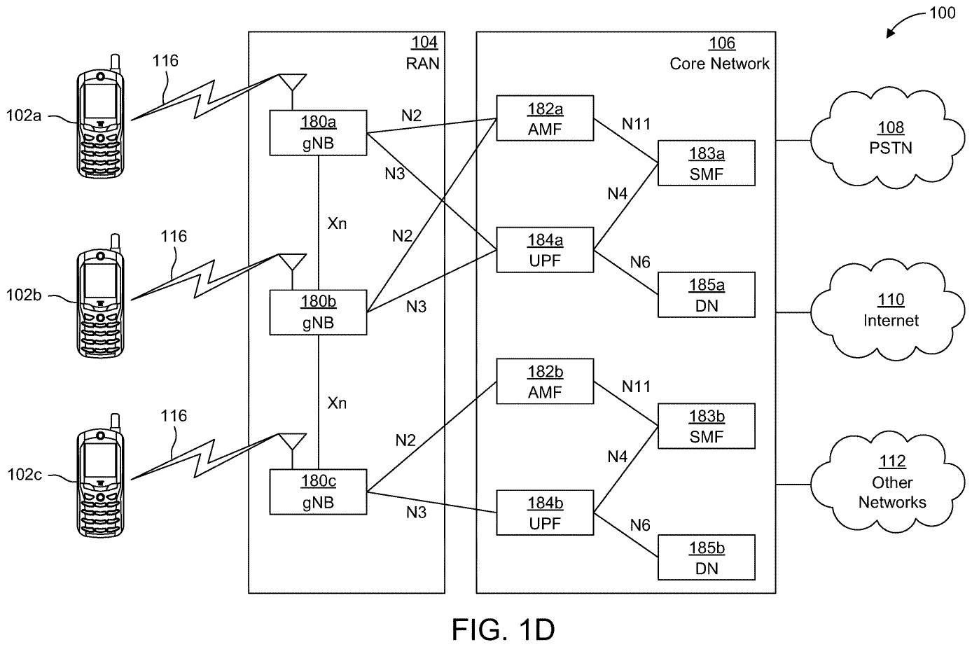

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a radio access network (RAN) 104, a core network (CN) 106, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a station (STA), may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106, the Internet 110, and/or the other networks 112. By way of example, the base stations 114a, 114b may be a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104, which may also include other base stations and/or network elements (not shown), such as a base station controller (BSC), a radio network controller (RNC), relay nodes, and the like. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed Uplink (UL) Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using NR.

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX), CDMA2000, CDMA2000 1X CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106.

The RAN 104 may be in communication with the CN 106, which may be any type of network configured to provide voice, data, applications, and/or voice over internet protocol (VoIP) services to one or more of the WTRUS 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104 and/or the CN 106 may be in direct or indirect communication with other RANs that employ the same RAT as the RAN 104 or a different RAT. For example, in addition to being connected to the RAN 104, which may be utilizing a NR radio technology, the CN 106 may also be in communication with another RAN (not shown) employing a GSM, UMTS, CDMA 2000, WiMAX, E-UTRA, or WiFi radio technology.

The CN 106 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs), any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors. The sensors may be one or more of a gyroscope, an accelerometer, a hall effect sensor, a magnetometer, an orientation sensor, a proximity sensor, a temperature sensor, a time sensor; a geolocation sensor, an altimeter, a light sensor, a touch sensor, a magnetometer, a barometer, a gesture sensor, a biometric sensor, a humidity sensor and the like.

The WTRU 102 may include a full duplex radio for which transmission and reception of some or all of the signals (e.g., associated with particular subframes for both the UL (e.g., for transmission) and DL (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the UL (e.g., for transmission) or the DL (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width. The primary channel may be the operating channel of the BSS and may be used by the STAs to establish a connection with the AP. In certain representative embodiments, Carrier Sense Multiple Access with Collision Avoidance (CSMA/CA) may be implemented, for example in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz, and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode) transmitting to the AP, all available frequency bands may be considered busy even though a majority of the available frequency bands remains idle.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 104 and the CN 106 according to an embodiment. As noted above, the RAN 104 may employ an NR radio technology to communicate with the WTRUs 102a, 102b, 102c over the air interface 116. The RAN 104 may also be in communication with the CN 106.

The RAN 104 may include gNBs 180a, 180b, 180c, though it will be appreciated that the RAN 104 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, DC, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 106 shown in FIG. 1D may include at least one AMF 182a, 182b, at least one UPF 184a, 184b, at least one Session Management Function (SMF) 183a, 183b, and possibly a Data Network (DN) 185a, 185b. While the foregoing elements are depicted as part of the CN 106, it will be appreciated that any of these elements may be owned and/or operated by an entity other than the CN operator.

The AMF 182a, 182b may be connected to one or more of the gNBs 180a, 180b, 180c in the RAN 104 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and the like. The AMF 182a, 182b may provide a control plane function for switching between the RAN 104 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 106 via an N11 interface. The SMF 183a, 183b may also be connected to a UPF 184a, 184b in the CN 106 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing DL data notifications, and the like. A PDU session type may be IP-based, non-IP based, Ethernet-based, and the like.

The UPF 184a, 184b may be connected to one or more of the gNBs 180a, 180b, 180c in the RAN 104 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering DL packets, providing mobility anchoring, and the like.

The CN 106 may facilitate communications with other networks. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local DN 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

The following are descriptions of examples of mobile positioning methods. In Rel. 16, downlink, uplink and downlink and uplink positioning methods are used.

A “DL positioning method” may refer to any positioning method that uses downlink reference signals such as positioning reference signal (PRS). The WTRU receives multiple reference signals from transmit points (TP(s)) and measures downlink received signal time difference (DL RSTD) and/or reference signal received power (RSRP). Examples of DL positioning methods are downlink angle of departure (DL-AoD) or downlink time difference of arrival (DL-TDOA) positioning.

An “UL positioning method” may refer to any positioning method that uses uplink reference signals such as sounding reference signal (SRS) for positioning, referred to herein as a SRSp. The WTRU transmits SRS to multiple receive points (RPs) and the RPs measure the uplink relative time of arrival (UL RTOA) and/or RSRP. Examples of UL positioning methods are uplink time difference of arrival (UL-TDOA) or angle of arrival (UL-AoA) positioning.

A “DL & UL positioning method” may refer to any positioning method that uses both uplink and downlink reference signals for positioning. In one example, a WTRU transmits SRS to multiple transmit receive points (TRPs) and the gNB measures Rx-Tx time difference which is calculated based on the time of arrival of the DL RS (e.g., PRS). The gNB can measure RSRP for the received SRS. The WTRU measures Rx-Tx time difference for PRS transmitted from multiple TRPs. The WTRU can measure RSRP for the received PRS. The Rx-TX difference and possibly RSRP measured at WTRU and gNB are used to compute round trip time. Here “WTRU Rx-Tx time difference” refers to the difference between arrival time of the reference signal transmitted by the TRP and transmission time of the reference signal transmitted from the WTRU. An example of a DL & UL positioning method is multi-cell round trip time (multi-RTT positioning).

Artificial intelligence (AI) may be broadly defined as the behavior exhibited by machines that mimics cognitive functions to sense, reason, adapt, act, and providing the ability to discern patterns. Machine learning (ML) may refer to type of algorithms that solve a problem based on learning through experience (‘data’), without explicitly being programmed (‘configuring set of rules’). Machine learning can be considered as a subset of Al and thus the term AIML is used to connotate such systems. Different machine learning paradigms may be envisioned based on the nature of data or feedback available to the learning algorithm. For example, a supervised learning approach may involve learning a function that maps input to an output based on labeled training example, wherein each training example may be a pair consisting of input and the corresponding output. For example, unsupervised learning approach may involve detecting patterns in the data with no pre-existing labels. For example, reinforcement learning approach may involve performing sequence of actions in an environment to maximize the cumulative reward. In some solutions, it is possible to apply machine learning algorithms using a combination or interpolation of the above-mentioned approaches. For example, semi-supervised learning approach may use a combination of a small amount of labeled data with a large amount of unlabeled data during training. In this regard semi-supervised learning falls between unsupervised learning (with no labeled training data) and supervised learning (with only labeled training data).

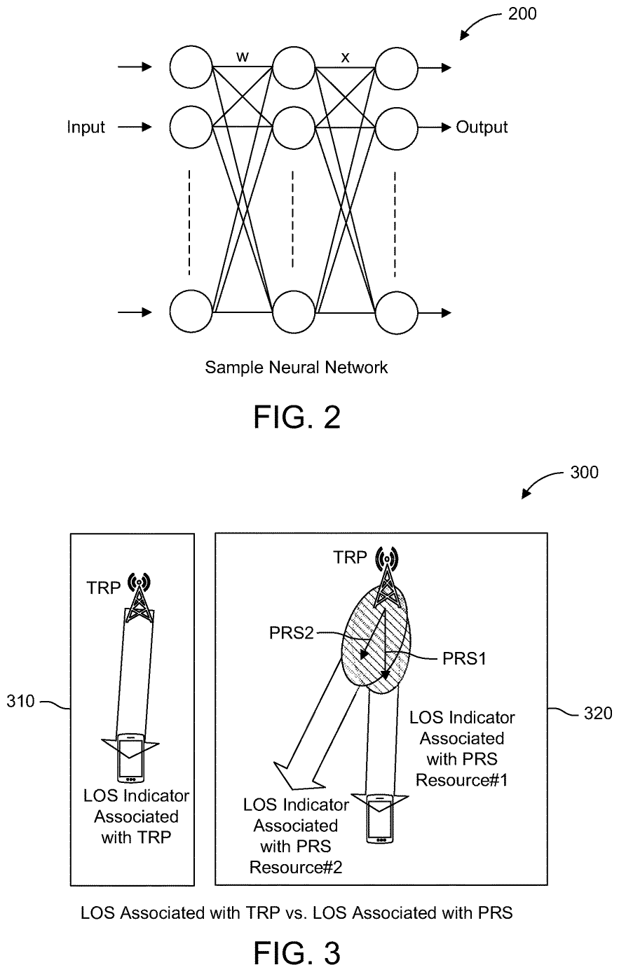

Referring to FIG. 2, one of example of a neural network 200 is shown. The objective of training is to apply input and adjust weights, indicated as w and x in network 200 (which may be referred to as neuron weights or link weights), such that the output from the neural network approaches the desired target values which are associated with the input values. In the example of FIG. 2, a neural network 200 consists of 3-layers. During the training, for given input, the difference between output and desired values are computed and a difference is used to update the weights w and/or x in the neural network 200. If a large difference between output and desired values is observed, large changes in weights are expected while a small difference will lead to small changes in weights w and/or x.

For example, for positioning, input can be reference signal parameters and output can be an estimated position. The desired value can be location information acquired by a global navigation satellite system (GNSS) with high accuracy. Once the neural network 200 completes its training (e.g., the difference between the output and desired values is below a specified threshold), it can be applied for positioning by feeding input and using the output as the expected outcome for the associated input. The output may be an estimated position or location of the WTRU. Thus, for training a neural network, it is important to identify the: An input for the neural network; an expected output associated with the input; and an actual output from the neural network against which the target values are compared. As an example, a neural network model can be characterized by the number of weights, the number of layers in a neural network and the number of neurons per layer.

Deep learning refers to class of machine learning algorithms that employ artificial neural networks (specifically deep neural networks (DNNs) which were loosely inspired from biological systems and include at least one hidden layer. DNNs are a special class of machine learning models inspired the human brain wherein the input is linearly transformed and passed through a non-linear activation function multiple times. DNNs typically consists of multiple layers where each layer consists of linear transformation and a given non-linear activation function. The DNNs can be trained using the training data via a back-propagation algorithm. Recently, DNNs have shown state-of-the-art performance in a variety of domains, e.g., speech, vision, natural language, etc., and for various machine learning settings including supervised, un-supervised, and semi-supervised. The terms, “events” or “occasions” may be used interchangeably in this disclosure.

As mentioned previously, current networks (e.g., a location management function (LMF) or gNB) can indicate a hard or soft LOS indicator per TRP or per PRS resource to the WTRU. Further, the WTRU can indicate a hard or soft line of sight (LOS) indicator per TRP or per PRS resource to the network (e.g., LMF, gNB). AIML models can be trained to generate LOS indicators as labels or estimates based on inputs (e.g., measurements). LOS indicators can be generated by the WTRU or network, and conventionally, the quality of the generated LOS indicator is not verified by the WTRU or network. Thus, when the network or the WTRU trains an AIML model by setting the LOS indicator, either generated by the WTRU or network, as the desired target, and if the LOS indicator is not verified, the output (e.g., inference) of the AIML model (e.g., inferred LOS indicators) may not be reliable. Embodiments that follow include aspects to increase reliability of the LOS indicators.

In one method, a sounding reference signal for positioning (SRSp) transmission may be used for verification of a determined LOS indicator. As an example, a WTRU is configured with downlink positioning reference signal (PRS) and sounding reference signal (SRS) configurations, a target transmit receive point (TRP) and LOS indicator threshold and time threshold (e.g., N slots) by the LMF. The WTRU is further configured with PRS and SRS resources by the LMF. In one example operation, the WTRU receives a request to verify the LOS indicator for the configured target TRP and the WTRU sends a message to the network, accepting the request. The WTRU receives a SRS resource ID. The WTRU makes measurements on a received PRS(s) and determines the LOS indicator for the target TRP. The determined LOS indicator is compared to the configured LOS indicator threshold and transmits an SRSp associated with the indicated SRS resource ID if the LOS indicator is below the threshold.

In some cases, the LOS indicator may fall below the threshold, but the WTRU cannot transmit a positioning SRS within the configured time threshold since the WTRU received the PRS. In this case, the WTRU may report that the verification procedure cannot be completed to the LMF/gNB. The WTRU reports measurements (e.g., reference signal received power (RSRP)), WTRU location and determined LOS indicator (based on the received PRS) associated with the target TRP to the network.

In various embodiments, a WTRU may send a request to the network for configuration (e.g., PRS configurations, SRSp configurations) in the physical uplink shared channel (PUSCH), the physical uplink control channel (PUCCH), as uplink control information (UCI), via medium access control layer control element (MAC-CE) and/or radio resource control (RRC) or as a LTE positioning protocol (LPP) message. The request from the WTRU may include requested configurations of a measurement gap, a PRS processing window or window for transmission of SRS for positioning (SRSp).

The WTRU may send an acknowledgement message in PUSCH or PUCCH for the grant received from the network. A time window, as used herein, may be configured by the network. The WTRU may receive more than one configurations (e.g., durations) of the time window and the WTRU may determine which time window is activated based on an activation command associated with the window, received from the network.

In various embodiments, more than one condition/criteria can be used in a combination. The WTRU may be configured with more than one condition and associated WTRU behavior and the WTRU may determine which behavior to use based on the applicable condition. In some examples, the WTRU can measure DL-PRS inside or outside of the active bandwidth part (BWP) and/or may transmit the SRSp inside or outside of active BWP. The WTRU may be preconfigured with parameters (e.g., measurement gaps, PRS processing windows, PRS configurations, SRSp configurations) via a semi-static message (e.g., LPP, RRC). The WTRU may be configured with actions/rules provided by the network and according to the rule(s), the WTRU may determine to take an associated action.

In addition to the measurements made on a PRS, the WTRU may include at least one of the following cell-related measurements: synchronization signal reference signal received power (SS-RSRP) from the serving cell with corresponding cell ID; SS-RSRP from the neighboring cell(s) with corresponding cell ID(s); RSRP of a channel state information reference signal (CSI-RS) with CSI-RS resource ID; and/or RSRS of a demodulation reference signal (DM-RS).

As used herein, the following terms have the following meaning(s): “Network” may include an access and mobility management function (AMF), a location management function (LMF), a next generation NodeB (gNB) and/or next generation radio access network (NG-RAN), and their equivalents or future related nodes/functions. “Pre-configuration” and “configuration” may be used interchangeably. “Non-serving gNB” and “neighboring gNB” may be used interchangeably. “gNB” and “TRP” may be used interchangeably. “PRS”, “SRS”, “SRS for positioning” (SRSp) or “SRS for positioning purpose” may be used interchangeably. “PRS” or “PRS resource” may be used interchangeably. “PRS(s)” or “PRS resource(s)” may be used interchangeably and “PRS(s)” or “PRS resource(s)” may belong to different PRS resource sets. “PRS” or “DL-PRS” or “DL PRS” may be used interchangeably. “Measurement gap” or “measurement gap pattern” may be used interchangeably and “measurement gap pattern” may include parameters such as measurement gap duration or measurement gap repetition period or measurement gap periodicity. “ID” may be used interchangeably with “index.”

A positioning reference unit (PRU) may be a WTRU or TRP whose location (e.g., altitude, latitude, geographic coordinate, or local coordinate) is known by the network (e.g., gNB, LMF). Capabilities of a PRU may be the same as a WTRU or TRP, e.g., capable of receiving a PRS or transmitting a SRS or SRS for positioning (SRSp), return measurements, or transmit a PRS. The WTRUs acting as PRUs may be used by the network for calibration purposes (e.g., correct unknown timing offset, correct unknown angle offset).

An LMF is a non-limiting example of a node or entity (e.g., network node or entity) that may be used for, or to support, positioning. Any other node or entity may be substituted for an LMF and still be consistent with this disclosure. In various embodiments, the WTRU may receive a preconfigured threshold(s) from the network (e.g., LMF, gNB).

The LOS indicator may be hard (e.g., =1 or =0) or soft indicator (e.g., =0, 0.1,0.2 . . . , 1) and indicates likelihood of the presence of a LOS path between a TRP and a WTRU or along the PRS path. The LOS indicator can be associated with a TRP or PRS resource ID (e.g., index). The WTRU may receive the LOS indicator from the network per TRP or resource ID. Alternatively, the WTRU may determine the LOS indicator per TRP or resource ID based on measurements. The LOS indicator is used to quantify a likelihood of the line-of-sight between the WTRU and TRP and/or PRS/SRSp Tx direction. A NLOS indicator is used to quantify likelihood of the non-line-of-sight between the WTRU and TRP and/or PRS/SRSp Tx direction. The LOS indicator and NLOS indicator may be used interchangeably, irrespective of determinations, for example a LOS indicator may indicate a NLOS path or vice versa. That is, an indicator regarding line of sight is not specific to any determination. Lastly, as used herein, a WTRU location may, for example, be expressed in terms of altitude, latitude, geographic coordinate, or local coordinate.

In certain embodiments, configurations of reference signal (RS) for positioning may include configurations for positioning reference signal (PRS). In one example, a PRS configuration may contain at least one of the following parameters: number of symbols, transmission power, number of PRS resources included in a PRS resource set, muting pattern for PRS (for example, the muting pattern may be expressed via a bitmap), periodicity, type of PRS (e.g., periodic, semi-persistent, or aperiodic), slot offset for periodic transmission for PRS, vertical shift of PRS pattern in the frequency domain, time gap during repetition, repetition factor, resource element (RE) offset, comb pattern, comb size, spatial relation, quasi co-location (QCL) information (e.g., QCL target, QCL source) for PRS, number of positioning reference units (PRUs), number of TRPs, Absolute Radio-Frequency Channel Number (ARFCN), subcarrier spacing, expected reference signal timing difference (RSTD), uncertainty in expected RSTD, start Physical Resource Block (PRB), bandwidth, BWP ID, number of frequency layers, start/end time for PRS transmission, on/off indicator for PRS, TRP ID, PRS ID, cell ID, global cell ID, PRU ID, and applicable time window. The WTRU may apply a PRS configuration under a condition that the current time is within the applicable time window.

In various embodiment, configurations of RS for positioning may include configurations for SRS, or SRS for positioning, also referenced as “SRSp.” In one example, a SRS for positioning (SRSp) or SRS configuration may include at least one of: resource ID; comb offset values, cyclic shift values; start position in the frequency domain; number of SRSp symbols; shift in the frequency domain for SRSp; frequency hopping pattern; type of SRSp (e.g., aperiodic, semi-persistent or periodic); sequence ID used to generate SRSp, or other IDs used to generate SRSp sequence; spatial relation information, indicating which reference signal (e.g., DL RS, UL RS, CSI-RS, SRS, DM-RS) or synchronization signal/SSB (e.g., SSB ID, cell ID of the SSB) the SRSp is related to spatially, where the SRSp and DL RS may be aligned spatially; quasi colocation (QCL) information (e.g., a QCL relationship between SRSp and other reference signals or synchronization signal block (SSB)); QCL type (e.g., QCL type A, QCL type B, QCL type D); resource set ID; list of SRSp resources in the resource set; transmission power related information; pathloss reference information which may contain an index for SSB, CSI-RS or PRS; periodicity of SRSp transmission; and/or spatial information such as spatial direction information of SRSp transmission (e.g., beam information, angles of transmission, e.g., angle of departure (AoD)), spatial direction information of DL RS reception (e.g., beam ID used to receive DL RS, angle of arrival). “ID” may be used interchangeably with “index.”

According to the disclosed embodiments, various measurements are used for determining positioning information. In one example, RSTD may be defined by the difference in time of arrival between PRSs transmitted from a reference TRP and target TRP. The WTRU may be configured with the reference TRP index and target TRP index. The WTRU may be configured with the PRS resource indices to make measurements and the WTRU may determine the time of arrival from a TRP (reference or target) based on one or more PRS resources associated with the TRP. In another example, the RSTD may be defined as the difference in time of arrival between the reference PRS transmitted from a TRP and the target PRS transmitted from a TRP.

In one example, “WTRU Rx-Tx time difference” refers to the difference between arrival time of the reference signal transmitted by the TRP and transmission time of the reference signal transmitted from the WTRU. The WTRU Rx-Tx time difference may be associated with a PRS resource ID and/or SRSp resource ID. In another example, the WTRU may measure RSRP or reference signal received path power (RSRPP) if there are more than one paths observed on the PRS. In another example, the WTRU may make phase measurements on the PRS or phase measurement per path. In another example, the WTRU may determine channel impulse response (CIR) or power delay profile of the channel based on measurements made on PRS resource(s) transmitted from TRP(s).

Aspects and advantages of the disclosed embodiments include the WTRU or network being able to train AIML models with verified LOS indicators (or verified ground truth) and a reliability of inference generated by the trained AIML models will increase.

Methods for verification of a LOS indicator of various embodiments will now be described. In one example, the WTRU may be configured with PRS and SRSp configurations by the network (e.g., LMF, gNB). In addition, the WTRU may be configured with PRS and SRSp resources by the network.

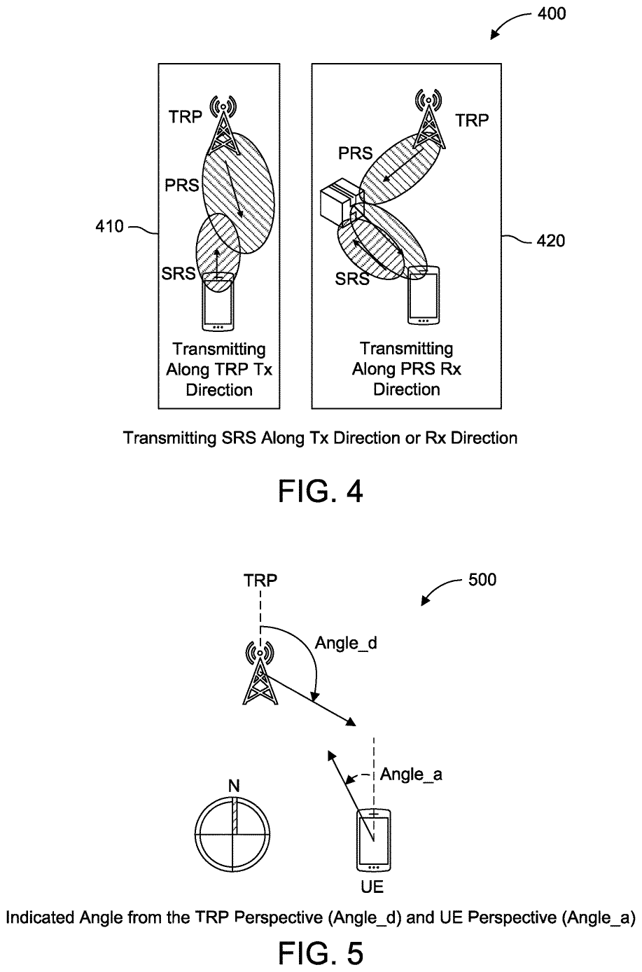

As described herein, there may be two types of LOS indicators of the present embodiments. One type of the indicator is associated with a TRP. For example, the LOS indicator is used to indicate whether there is a line-of-sight path or likelihood of a line-of-sight path between the WTRU and a TRP. Another type of LOS indicator is associated with a PRS resource. In the latter type, the LOS indicator is used to indicate whether there is a line-of-sight path, or likelihood of a line-of-sight path, along the direction that a PRS is transmitted. Examples are illustrated in FIGS. 3 and 4 where the left subfigure depictions in each indicate the case when the LOS indicator is associated with the TRP and the right subfigure depictions indicate the case when the LOS indicator is associated with a PRS resource.

In reference to FIG. 3 network diagram 300, an example illustration 310 of LOS associated with a TRP (left side) vs. an example illustration 320 of LOS associated with PRS (right side) are shown. In one example method, the WTRU may receive a request from the network to verify a LOS indicator or perform a verification procedure. The LOS indicator may be generated by the WTRU based on the measurements made on the received PRS. Alternatively, the network may request the WTRU to verify the LOS indicator associated with PRSs. The WTRU may transmit a response for the LOS verification request. For example, the WTRU may send “Yes” (e.g., accept the request from the network) to the request if the WTRU is capable of performing verification or receives both PRS and SRSp configurations necessary for verification. The WTRU may send “No” to the request if one of the aforementioned conditions is not satisfied.

In one embodiment, the LOS verification request may indicate: a request to verify the LOS indicator(s) associated with the indicated TRP(s), e.g., as shown by illustration 310, or the LOS indicator(s) associated with indicated PRS resource(s), e.g., as shown by illustration 320; a time limit for the verification procedure (e.g., the verification procedure must be completed within N hours/slots/frames/subframes/ symbols from the time the WTRU receives the request or accepts the request from the network); and/or one or more termination conditions of the verification procedure (e.g., the verification is completed by the WTRU reporting measurements and LOS indicator for the requested PRS resource(s) or TRP(s), and transmitting one or more configured SRSps). The WTRU determines that the verification procedure is complete when the termination condition is satisfied. In one example, the time limit for the verification procedure may be configured by the network.

In certain embodiments, a method for a WTRU may include the WTRU communicating capability/availability for LOS indicator verification. In one example, the WTRU may be configured to indicate whether it supports LOS indicator verification as part of WTRU capability reporting. For example, the WTRU may include additional information about its LOS indicator verification capability including the request contents described above (e.g., including but not limited to granularity of LOS verification, per TRP and/or per PRS), latency of such indication (e.g., time delay between PRS reception at the WTRU to the SRSp transmission at the WTRU—possibly including the latency for LOS determination at the WTRU), time limit for verification, termination condition, etc. In certain embodiments, the timing of WTRU capability transmission may implicitly indicate that the WTRU is ready for a LOS indicator verification procedure. Alternately, the WTRU may send the availability indication for LOS indicator verification procedure based on one or more conditions. For example, the WTRU may be configured to send the availability indication based on the PRS reception status (e.g., RSRPP is above a threshold), LOS confidence is above a threshold, based on location and/or time, based on WTRU RRC state (e.g., in CONNECTED state), or similar factors.

According to some embodiments, a verified LOS indicator may include a quality of verification. In one example, the WTRU may receive an indication from the network associated with a LOS indicator, indicating the LOS indicator is verified. The WTRU may be configured to use the verified LOS indicator for training AIML models by using the verified LOS indicator as the desired output of the AIML model during training. For some embodiments, verification on the LOS indicator may have validity conditions (e.g., time validity, area validity). For example, the WTRU may be configured with a duration (e.g., N days, M slots) during which verification of the LOS indicator is valid. The WTRU may be configured with the starting and/or end time for the verified LOS indicator. In one example, the WTRU may determine that the verification becomes invalid after the timer for the verification procedure expires or duration of the verification procedure exceeds the limit.

In some embodiments, quality of verification on the LOS indicator may be indicated by a hard indicator (e.g., 1=verified, 0=not verified). In another example, verification may be indicated by a soft indicator (e.g., 1=strongly verified, 0.5=mildly verified, 0=weakly verified). For some embodiments, verification may be indicated only when the LOS indicator is verified and/or verification may not be indicated when the TRP or PRS resource is not verified. In one example, the WTRU may determine to use the verified LOS indicator for training if the verification indicator is above a configured threshold.

According to various embodiments, the WTRU may determine to use measurements associated with the verified LOS indicator if the verified LOS indicator is associated with a PRS resource. In another example, if quality of verification for the LOS indicator is above a configured threshold, the WTRU may determine to use the measurements associated with the LOS indicator for training the AIML model. For example, if the WTRU makes measurements on the PRS resource (e.g., RSRSP, RSRPP, CIR) which is associated with the verified LOS indicator, the WTRU may use the measurements for training AIML models, setting the verified LOS indicator as the desired target.

In other example embodiments, if the verified LOS indicator is associated with a TRP, the WTRU may determine to use measurements made on a PRS transmitted from the TRP for training the AIML model, using the verified LOS indicator as the target output. In another example, an RSTD measurement is defined based on the difference between time of arrival (ToA) of PRS resources transmitted from the target TRP and a reference TRP. The WTRU may use reference signal timing difference (RSTD) as inputs for training an AIML model only if LOS indicators for PRS resources associated with target TRP and reference TRP are verified.

Referring to FIG. 4, diagram 400 shows examples of transmitting SRS along a Tx direction 410 or Rx direction 420. In one example, the WTRU may be configured to determine the LOS indicator for the PRS resource where the PRS resource may be indicated by the network (e.g., LMF, gNB). In another example, the WTRU may be configured to determine the LOS indicator for the TRP indicated by the network (e.g., by TRP ID or PRS ID).

In some embodiments, the WTRU may be configured to determine the LOS indicator for an SRSp resource. For example, the network may indicate the SRSp resource ID and the WTRU determines the LOS indicator associated with the SRSp resource ID. The WTRU may report to the network the LOS indicator associated with the SRSp resource ID.

For certain embodiments, the WTRU may determine the LOS indicator associated with the SRSp resource ID when the WTRU receives the PRS resource which is spatially aligned or correlated with the SRSp resource ID. For example, the WTRU may receive a configuration from the network indicating that PRS resource #1 and SRSp resource #3 are spatially related, aligned or correlated. The WTRU may make measurements on the PRS #1 resource and determines the LOS indicator for the SRSp resource #3, and report it to the network.

Referring to FIG. 5, in another example diagram 500, the WTRU may determine the LOS indicator for the angle indicated by the network. The angle may be defined as the angle with respect to the reference TRP. As shown in FIG. 5, where the WTRU is requested to indicate the LOS indicator for the angle indicated by the network (Angle_d) where the angle is defined with respect to the geographical North (e.g., in a global coordinate system). In FIG. 5, an indicated angle from the TRP perspective (Angle_d) is different from the WTRU perspective (Angle_a).

In one example, the WTRU may determine the LOS indicator for an angle (e.g., from the perspective of the WTRU or TRP) or LOS indicators for angles. The WTRU may report to the network LOS indicators determined for angles. In one example, the WTRU may be configured with a range of angles to make measurements on configured DL-RSs (e.g., PRSs). In another example, the WTRU may be requested by the network to report LOS indicators (e.g., up to N angles where each angle is associated with a LOS indicator) within the range of angles. In another example, the WTRU may be configured with more than one PRS resource to make measurements on and report the LOS indicator(s) associated with angle(s). The WTRU may determine to associate the LOS indicator(s) with angle(s) if the indicator is below or above a configured threshold.

The WTRU may determine to indicate the LOS indicator for an angle within the configured range and may be configured with the maximum number of angles, e.g., N angles, to associate the LOS indicator(s). The WTRU may be configured to report up to N angles within the configured range. In certain examples, the WTRU may be configured with granularity of angles to associated LOS indicators where examples of the granularities can be 10-degrees, 1-degree, 0.1-degree, 0.01-degree.

In one example, the WTRU may report a LOS indicator per configured range of angles (e.g., [30-degrees to 60-degrees] from the WTRU perspective with a reference to the geographical North). The WTRU may be configured with a range of angles by the network and may receive a request from the network to report a LOS indicator for the configured range(s) of angles. The angles may be defined according to the TRP or WTRU perspective similar to examples illustrated in FIG. 5. Based on the measurements on configured PRS resources, the WTRU may determine to report the LOS indicator per configured range of angles.

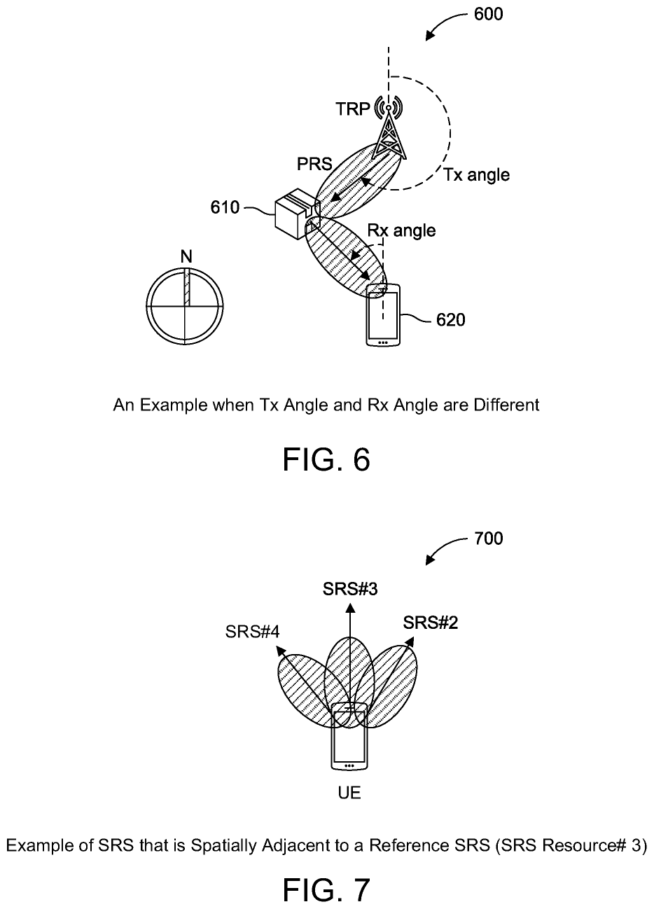

Example SRSp transmission conditions will now be described. In one embodiment, the WTRU may determine to verify the LOS indicator associated with a PRS or TRP by transmitting the configured SRSp when at least one, or combinations, of the following example conditions is satisfied:
(1) The determined LOS indicator may be below the threshold (e.g., the LOS indicator is 0.4 and the threshold is 0.7).
(2) The WTRU receives from the network, a LOS indicator associated with a PRS resource or TRP. When the LOS indicator is above a threshold, the WTRU measures more than one path in the measurement (e.g., more than one ToA, AoA for the PRS resource the WTRU made measurements).
(3) The RSRP or RSRPP for the first path for the indicated PRS resource is below the threshold.
(4) Uncertainty, variance, standard deviation or higher order moments (e.g., skewness, kurtosis) in measurements (e.g., RSTD, RSRP, RSRPP, ToA, AoA, CIR) is above the threshold where the WTRU is configured with a window or duration of measurements on which the WTRU determines uncertainty.
(5) Uncertainty, variance or standard deviation in the determined LOS indicator (e.g., hard or soft LOS indicator) is above the threshold where the WTRU is configured with a window or duration of measurements on which the WTRU determines uncertainty.
(6) A difference between a Rx direction (e.g., in degrees) of the PRS is different from a Tx direction (e.g., degrees) is above a configured threshold. The WTRU may receive information about an AoD (angle of departure) for each PRS from the network. The AoD may be associated with a PRS resource ID. The WTRU may determine an AoA (angle of arrival) for each PRS and compute the difference between the AoD and AoA. The WTRU may translate AoA with a configured function (e.g., AoA-180 degrees) so that a difference between AoD and translated AoA are computed based on a same reference. Referring to FIG. 6 an example 600 is shown where Tx angle and Rx angle are different. In the illustrated example 600, the PRS transmitted from the TRP is reflected against an object 610 and received by the WTRU 620.
(7) Within the configured range of angles by the network, the WTRU determines LOS indicator for at least one of the angles.
(8) For a given LOS indicator value, measurement made of a PRS is above or below a threshold (e.g., the number of paths). For example, if the LOS indicator is 0.9 and the number of paths observed in the measurements (e.g., ToA) is above a threshold (e.g., 4), the WTRU determines to verify the LOS indicator (e.g., by transmitting a configured SRSp). In one example, the WTRU may be configured with an association table where, for example, a range of LOS indicator values are associated with a threshold for channel characteristics (e.g., number of paths). In one example, the configured range may be 0.2<LOS indicator<=0.4 (“ <=” denotes less or equal to), threshold for the number of paths is four, and the WTRU transmits the SRSp if the number of paths is smaller than the threshold and the LOS indicator is within the range.
(9) For the requested angle by the network, the WTRU determines LOS indicator.

Any of the above conditions may also be applicable for the WTRU to determine whether the verification procedure should be initiated or not. For example, if at least one of the above conditions is satisfied, the WTRU may determine to initiate the LOS verification procedure.

Embodiments for positioning using verified LOS indicators may be conditioned on hard or soft indicators. In one example, the WTRU may be configured by the network to determine a hard indicator. In another example, the WTRU may be configured by the network to determine a soft indicator. In one embodiment, for example, the WTRU may be configured to indicate a hard or soft indicator (e.g., =1 or =0, LOS or NLOS) and soft indicator (e.g., =0, 0.1, . . . , 0.9, 1). Based on the measurements made on a received PRS(s), the WTRU may determine to report a hard indicator associated with the indicated PRS resource or indicated TRP. The WTRU may determine to associate a hard indicator with the configured PRS(s) or TRP(s) if at least one of the number of configured PRS resources for measurements is below a threshold or the number of paths measured for a PRS resource is below a threshold.

The WTRU may alternatively determine to associate a soft indicator with the configured PRS(s) or TRP(s) if at least one of: (i) the number of configured PRS resources for measurements is above a threshold; (ii) the number of paths measured for a PRS resource is above a threshold; or (iii) the number of paths measured for a PRS resource is below a threshold. If the WTRU determines that the hard indicator associated with the PRS or TRP is =0 (e.g., NLOS), the WTRU may determine to transmit the configured SRSp(s).

In certain embodiments, SRSp transmission may be an implicit indication of LOS indicator based on SRSp resource selection. For example, the WTRU may be configured to determine one or more parameters of SRSp transmission as a function of LOS status of received PRS. In one example, the WTRU may be configured with a first SRSp resource/configuration and a second SRSp resource/configuration where, the first SRSp configuration may be associated with a first SRS sequence ID and the second SRSp configuration may be associated with a second sequence ID. In another example, the first SRSp configuration may be associated with a first freqDomainPosition and/or freqDomainShift and/or cyclic shift and/or resource mapping and/or comboffset, or similar configuration, and the second SRSp configuration may be associated with a second freqDomainPosition and/or freqDomainShift and/or cyclic shift and/or resource mapping and/or comboffset or similar configuration. In one example, the WTRU may be configured with an association between the first and second SRSp resource/configuration to a PRS resource/configuration. The WTRU may be configured to receive the PRS and determine the LOS status/indicator associated with the PRS. If the LOS indicator is above a threshold, then the WTRU may transmit using the first SRSp resource/configuration. If the LOS indicator is below a preconfigured threshold, then the WTRU may transmit SRS using the second SRSp resource/configuration.

For another example, if the hard LOS indicator is =1, then the WTRU may transmit using the first SRSp resource/configuration. If the hard LOS indicator is =0, then the WTRU may transmit the SRS using the second SRSp resource/configuration.

According to some embodiments, a time window may be used for tracking changes of LOS indicators. In one example, the WTRU may be configured with a time window by the network to verify the LOS indicator associated with a PRS or TRP. While the window is active (e.g., activated by a MAC-CE command), the WTRU may receive periodic PRSs. Based on the measurements made on received PRSs, the WTRU may determine the LOS indicator per PRS. The WTRU may transmit configured SRSp(s) for verification during the configured time window. The WTRU may report the determined LOS indicators and transmit configured SRSp(s) until the window is closed or deactivated. In one example, the time window may be characterized by start time (e.g., expressed in terms of absolute time, relative time with respect to an indicated or configured reference time), end time and/or duration (e.g., expressed in terms of seconds, number of slots, number of frames, number of subframes, number of symbols).

SRSp transmission behavior of certain example embodiments will now be described. In one example, the WTRU may receive configurations, associating a PRS and a SRS. The WTRU may receive a table associating one PRS resource ID and more than one SRSp resource IDs. In another example, the WTRU may receive a table associating more than one PRS resource IDs and one SRSp resource ID. The WTRU may determine to transmit SRSp(s) associated with the PRS if the WTRU determines to verify the LOS indicator associated with the received PRS. If there is more than one SRSp associated with the PRS, the WTRU may be configured to determine the order of transmission according to a configured rule (e.g., transmit from the SRSp with the lowest SRSp resource ID).

In another example, the WTRU may receive configurations associating a TRP and SRS(s). The WTRU may receive a table associating a TRP ID (e.g., PRS ID) and more than one SRSp resource IDs. If the WTRU determines to verify the LOS indicator associated with the TRP, the WTRU may determine to transmit the SRSp(s) associated with the TRP.

In the examples described herein, the WTRU may receive an indication, indicating the PRS resource ID to refer to the PRS. The WTRU may receive configurations (e.g., repetition factors) for the configured PRSs and SRSps.

For one embodiment, the WTRU may determine to transmit SRSp(s) based on the SRSp resource ID(s) indicated in a semi-static message (e.g., LPP, RRC) received from the network. In another example, the WTRU may be configured with a Tx direction specifying a direction that the indicated SRSp should be transmitted. The Tx direction may be indicated by referring to another UL RS (e.g., SRS, DMRS, phase tracking reference signal (PTRS), DL RS (e.g., CSI-RS, PTRS, TRS, DMRS, PRS) or angle (e.g., angle is defined with respect to the geographical North).

In one example, the WTRU may be given a time window or limit during which the WTRU is expected to transmit SRSp(s) associated with SRSp resource ID(s) indicated in a semi-static message (e.g., LPP, RRC). The time window may start when the WTRU receives the PRS associated with the time window and the duration of the time window may be expressed in terms of the number of symbols, slots, frames, subframes, etc.

Referring to FIG. 7, an example diagram 700 is shown where the WTRU may be configured to transmit N SRSps spatially adjacent to the referenced direction and/or reference RS (e.g., SRSp, PRS). For example, the WTRU may be configured with a reference RS such as SRSp resource #3. The WTRU may be configured to transmit N=2 SRSp that are spatially adjacent to SRS #3. FIG. 7 shows the WTRU is configured with the reference SRS #3 (center) and SRSs which are adjacent to the reference SRS are SRS #2 and SRS #4. The WTRU may receive SRS resource IDs associated with SRS #2, SRS #3 and SRS #4.

In one embodiment, the WTRU may determine to transmit the SRSp in the Rx direction from which the WTRU received a PRS. In this case, the WTRU may report an expected range of Rx direction, from the TRP perspective, for the TRP prior to transmitting the SRSp. In another example, the WTRU may be configured to transmit an SRS associated with the PRS after reception of the PRS. In one example, the WTRU may determine to transmit an SRS after reception of the PRS where the resource ID of the SRS is associated with the resource ID of the received PRS. The WTRU may be configured with a set of PRS reception and SRSp transmission configurations where each set includes PRS and SRSp configurations (e.g., PRS resource ID, SRSp resource ID).

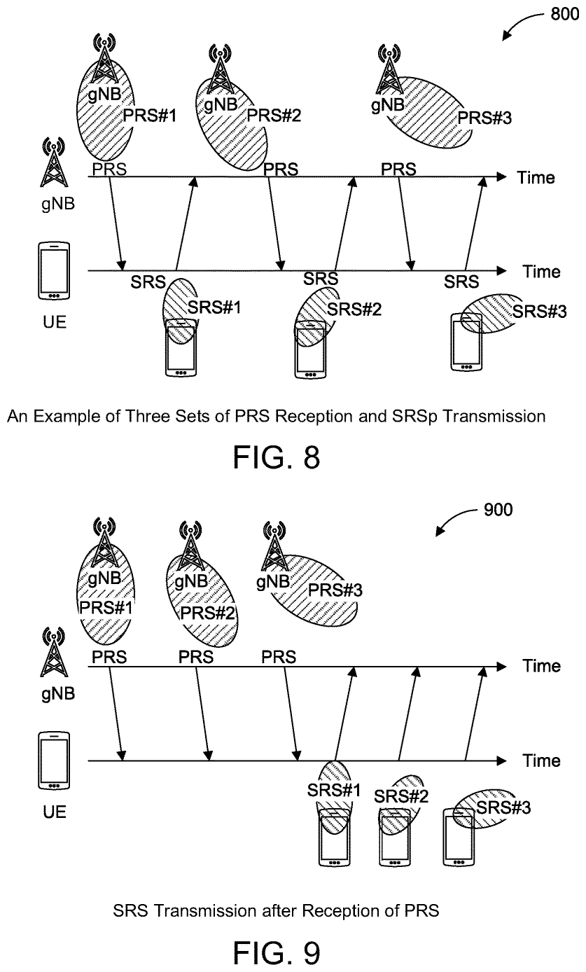

The WTRU may be configured to transmit SRSp after the WTRU receives PRS in the set. The WTRU may be configured with more than one set of PRS reception and SRSp transmission configurations. Referring to FIG. 8, an example diagram 800 is shown, where the WTRU is configured with three sets of PRS reception and SRSp transmission configurations. In the first set, the WTRU is configured to receive PRS #1 and transmit SRS #1 where the WTRU receives from the network resource ID associated with PRS #1 and SRS #1. In the second set, the WTRU is configured to receive PRS #2 and transmit SRS #2. In the third set, the WTRU is configured to receive PRS #3 and transmit SRS #3. In the example 800, it is assumed that each SRS or PRS corresponds to different Tx direction.

In one example, the WTRU may be configured with a set of PRS reception and SRSp transmission where the PRS resource and SRSp resource are associated in the configuration. For the example 800 of FIG. 8, the WTRU may receive a configuration or indication in which PRS #1 and SRS #1 are associated (e.g., PRS resource #1 and SRS resource #1 are associated), PRS #2 and SRS #2 are associated and PRS #3 and SRS #3 are associated.

For one embodiment, the WTRU may be configured with more than one set of PRS reception and SRSp transmission where in each set, different SRSp resource IDs are configured with the same PRS resource ID. For the example 800 in FIG. 8, in the first set, the WTRU is configured to receive PRS #1 and transmit SRS #1. In the second set, the WTRU is configured to receive PRS #2 and transmit SRS #2. Finally, in the third set, the WTRU is configured to receive PRS #3 and transmit SRS #3. In a different example, in the first set, the WTRU is configured to receive PRS #1 and transmit SRS #1. In the second set, the WTRU is configured to receive PRS #2 and transmit SRS #1. Finally, in the third set, the WTRU is configured to receive PRS #3 and transmit SRS #1.

Referring to FIG. 9, an example network diagram 900 is shown for embodiments of SRS transmission after reception of a set of PRSs during a window. In one example, the WTRU may be configured to transmit a set of SRSs after receiving a set of PRSs from the network. In the example illustrated in FIG. 9, the WTRU is configured to receive PRS #1, PRS #2 and PRS #3 and make measurements on each PRS. After the WTRU receives the configured PRSs, the WTRU is configured to transmit SRS #1, SRS #2 and SRS #3. After the WTRU transmits SRS #3, the WTRU returns measurements and determines LOS indicators.

In the aforementioned examples, at each transmission occasion (e.g., when the WTRU transmits SRS #1), the WTRU may be configured with a repetition factor (N) where the WTRU is expected to transmit an SRS N number of times. For example, if one SRSp transmission consists of 12-symbols in a slot and the WTRU is configured with a repetition factor N=4, the WTRU may transmit a 12-symbol SRS in 4-slots, where each slot contains the 12-symbol SRS.

In one example, the WTRU may be configured or requested, by the network, to transmit configured SRSp within the range of transmission or reception angles (e.g., from the WTRU perspective or the TRP perspective, as illustrated in FIG. 5 and discussed previously). In another example, the WTRU may transmit configured SRSp(s) at angle(s) requested or configured by the network. The WTRU may determine which SRSp to transmit based on a spatial relationship of the SRSp with the DL-RS (e.g., CSI-RS or PRS) or UL-RS (e.g., SRS, SRSp, PTRS, DMRS). Based on spatial relationship, the WTRU may determine whether the transmission angles of the SRSp are within the configured range of the angles. If there is more than one SRSp to transmit, the WTRU may determine the order of SRSp transmission according to the SRSp resource IDs associated with the SRSps (e.g., transmit each SRSp starting from the lowest ID to the highest ID). The WTRU may be configured with the maximum number (e.g., N) of SRSps to transmit. The WTRU may determine to prioritize SRSp transmissions along the angles where the angles are associated with N highest LOS indicators.

In some embodiments, if the WTRU is configured to report a LOS indicator within the range of angles or specific angle(s), the WTRU may determine to transmit a SRSp along the angle(s) that the WTRU determined LOS indicators. The WTRU may determine to transmit SRSp(s) along the angle(s) if the difference between the transmission angle and the angle that is associated with the LOS indicator is within the threshold.

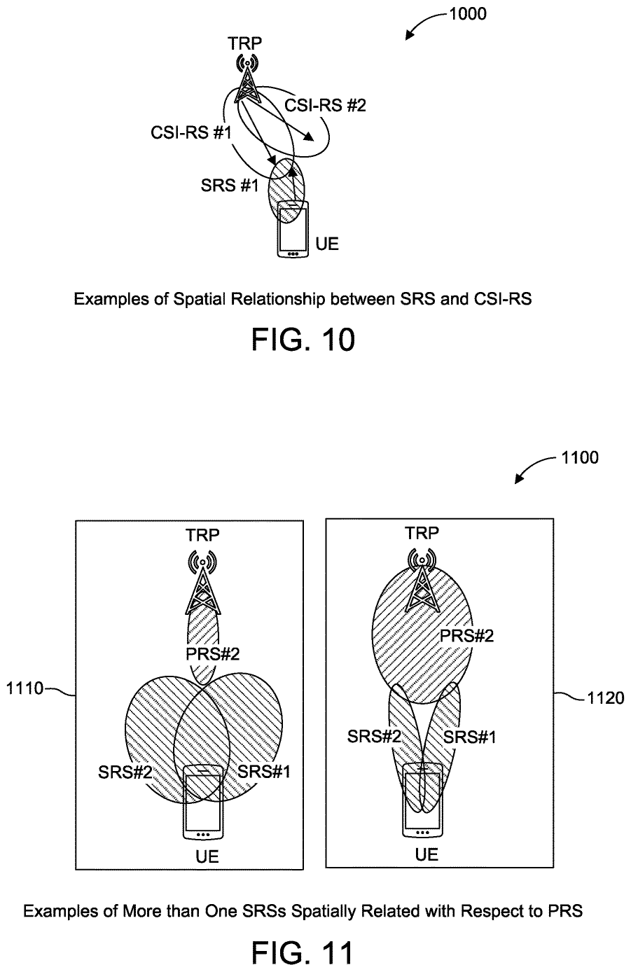

Turning to FIG. 10, a diagram 1000 shows examples of spatial relationships between SRS and CSI-RSs. In the example diagram 1000, SRS #1 and CSI-RS #1 are related spatially because their transmission direction is aligned spatially. However, SRS #1 and CSI-RS #2 are not related spatially because their transmission direction is not aligned spatially.

In some embodiments RSs may have spatial relationship information, for example, more than one SRSp may be spatially related to one PRS. This may be due to a different beamwidth of DL or UL transmission. If more than one SRSp may be spatially related to a PRS and the WTRU determines to transmit SRSps to verify the LOS indicator associated with the PRS (e.g., the LOS indicator the WTRU or network generated is below the configured threshold), the WTRU may determine to transmit SRSps in a configured order (e.g., start transmission of SRSps with the lowest resource index or ID).

Referring to FIG. 11, a spatial diagram 1100 is shown with two examples 1110, 1120 of spatially related RSs. In the left subfigure 1110, PRS #2 is spatially related to SRS #1 and SRS #2, both of which have relatively larger beamwidth compared to the PRS #2 beamwidth. In the right subfigure 1120 of FIG. 11, PRS #2 is spatially related to SRS #1 and SRS #2, of which both have relatively narrower beamwidth as compared to the PRS #2 beamwidth. If the WTRU determines to verify the LOS indicator the WTRU generated for PRS #2, the WTRU may determine to transmit SRSps in the order of the lowest SRSp resource index to the highest SRSp resource index, e.g., the WTRU transmit SRS #1 first and SRS #2 second.

Examples of failure cases for the verification procedure are now described. In one example, the WTRU may not be able to receive a PRS and/or process the measurements according to lower prioritization of receiving PRSs (e.g., the WTRU determines to instead, receive on the PDSCH which is associated with higher priority than receiving/measuring PRSs) after the WTRU accepts the request to verify the LOS indicator sent from the network. In another example, the WTRU may not be able to transmit an SRSp due to a lower prioritization of LOS indicator verification using SRSp (e.g., the WTRU determines to transmit on the physical uplink control channel (PUCCH) which is associated with a higher priority than transmitting SRSps) after the WTRU accepts the request to verify the LOS indicator.

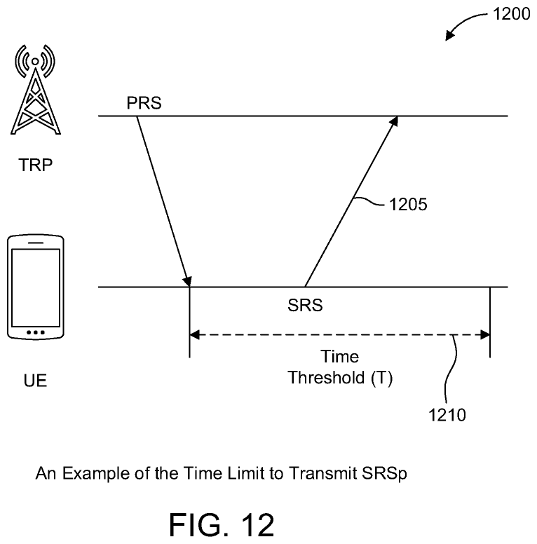

Referring to FIG. 12, network diagram 1200 shows one example embodiment of a potential LOS indicator verification failure case. As shown in diagram 1200, a WTRU is configured to transmit a SRSp 1205 within a specific window of time 1210. If, for example, the WTRU may not be able to transmit the SRSp 1205 within a specified/configured time limit 1210, for example, a time threshold from when the WTRU received a PRS, a LOS indictor verification failure may occur. The inability to transmit the SRSp 1205 within a given time 1210 may be due to various reasons, including a lower prioritization of SRSp transmission than other operations. For example, the WTRU may determine to transmit on the PUCCH during the time window, which has a higher priority than transmitting the SRSp. An example of the time limit, or window 1210, to transmit a given SRSp is shown in FIG. 12 where the WTRU is configured with a time threshold (T) (e.g., T-seconds, T-symbols, T-subframes, T-slots) in which to transmit a verification SRSp 1205. While FIG. 12 actually shows transmission of SRSp 1205 within window (T) 1210, if the WTRU cannot transmit the SRSp 1205 within the time limit T 1210, the WTRU declares a failure in the verification procedure.

In various examples, the WTRU may determine that the duration of the LOS indicator verification procedure exceeds a threshold time or window, due to a delay in reception of a PRS or delay in transmission of a SRS. In another example, the WTRU may not be able to transmit a SRSp within the time limit or window from receiving the PRS, due to failure to acquire UL resources for transmission of SRSp. In the event the WTRU cannot complete one or more LOS indicator verification procedures, the WTRU may report to the LMF (or other relevant function or node) that the WTRU could not complete the LOS indicator verification procedure. In some embodiments, the LOS indicator verification procedure may be repeated if previously failed, terminated or cancelled.

Reporting contents for various embodiments will now be described. According to some embodiments, the WTRU determines to report measurements (e.g., RSTD) associated with a determined LOS indicator to the network. The WTRU may make measurements and determine a LOS indicator for each configured PRS. For example, the WTRU may make measurements on each configured PRS and determine a LOS indicator for the target TRP. According to one embodiment, if the WTRU is configured with more than one set of PRS reception and SRSp transmission configurations, and the WTRU is configured or requested to report the LOS indicator for each PRS, the WTRU may determine to report the measurements (e.g., RSTD, RSRP, RSRPP) and a LOS indicator associated with the received PRS to the network, after or before, the WTRU transmits the SRSp for each set for LOS indicator verification. In one example, the WTRU may include a timestamp in the report where the timestamp may be expressed in terms of absolute time, relative time with respect to an indicated or configured reference time, SFN, frame index, symbol index, slot index and/or subframe index.

In another example, if the WTRU is configured with more than one set of PRS reception and SRSp transmission configurations and the WTRU is configured or requested to report the LOS indicator for an indicated TRP, the WTRU may report the measurements and/or a determined LOS indicator associated with the indicated TRP, after the last configured set of PRS reception and SRSp transmission (e.g., in the example of FIG. 8 discussed previously, the WTRU reports the measurements and/or LOS indicator for the target TRP only after the WTRU has received PRS #3 and transmitted SRS #3).

In certain embodiments, the WTRU may indicate a LOS verification status (e.g., hard or soft indicator) implicitly. For example, the WTRU may be configured with SRS parameters (e.g., SRS sequence or SRS sequence ID) or configuration the WTRU shall use for a LOS or NLOS indicator.

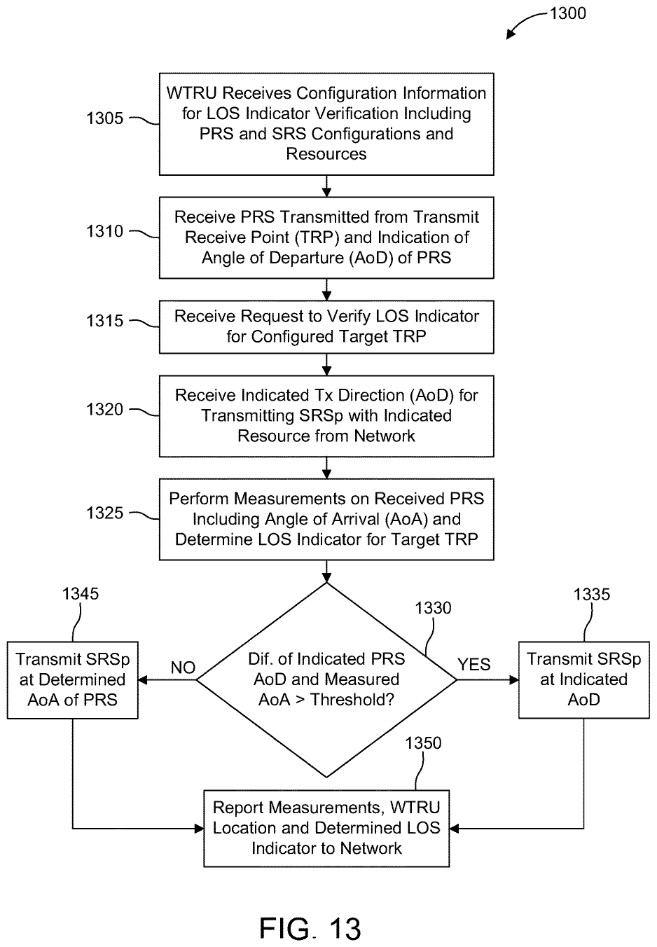

Referring to FIG. 13, a method 1300 of verifying LOS indicators for positioning information according to one example embodiment is shown. Method 1300 may generally begin by configuring 1305 the WTRU, i.e., the WTRU receives configuration information, with PRS and SRS configurations by the LMF (or other similar function or node). The WTRU is also configured 1305 with PRS and SRS resources by the LMF. The WTRU receives 1310 a PRS transmitted by a TRP and an angle of departure (AoD) of the transmitted PRS is indicated to the WTRU. The PRS is received 1310 by the WTRU at an angle of arrival (AoA). For example, when the WTRU receives 1315 a request to verify the LOS indicator for the configured target TRP the WTRU receives 1320 a transmit (Tx) direction with the AoD for transmitting a subsequent SRSp with resources indicated from the network. The WTRU performs measurements 1325 on the received PRS including the AoA and determines a LOS indicator for the target TRP. If 1330 the difference between indicated AoD of the PRS and the measured AoA the of PRS, is greater than the threshold, the WTRU transmits 1335 a SRSp at the indicated AoD. If 1330 the difference is less than the threshold, the WTRU may, or may not, transmit 1345 the SRSp at the measured angle of arrival of the PRS. This determination may help reduce errors due to PRS reflections. In various embodiments, the WTRU may report 1350 measurements (e.g., RSRP), WTRU location and determined LOS indicator (based on the received PRS) to the network.

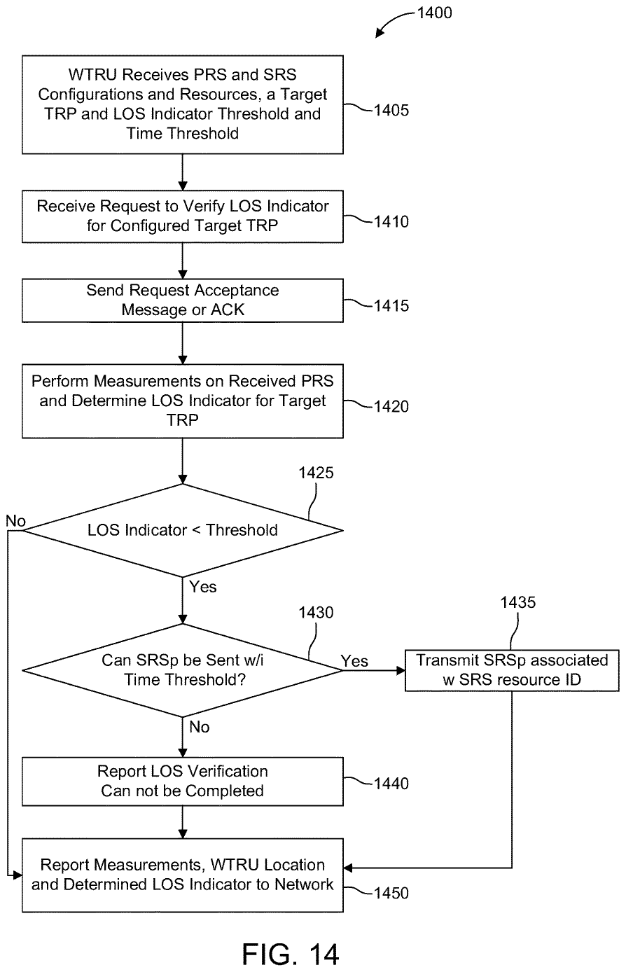

Referring to FIG. 14, according to another method 1400, the WTRU may be configured 1405 by the LMF, or other network node/function, with PRS and SRS configurations similar to previous embodiments. In this embodiment, a target TRP, a LOS indicator threshold and a time threshold (e.g., N slots) may be included in configuration information. The WTRU is also configured 1405 with PRS and SRS resources by the LMF/network node.

The WTRU receives 1405 a request to verify the LOS indicator for the configured target TRP. In certain embodiments, the WTRU may send 1415 a message to the network accepting the request or acknowledging the LOS indicator verification request. The WTRU receives a SRS resource ID and when receiving a PRS, will perform 1420 measurements on the PRS and determine the LOS indicator for the target TRP. In this embodiment, if 1425 the determined LOS indicator is below the configured threshold, and if 1430 the WTRU may transmit the SRSp within the configured time threshold from receiving the PRS, the WTRU transmits 1435 the SRSp associated with the indicated SRS resource ID.

If 1425 the LOS indicator is lower than the threshold but 1430 the WTRU cannot transmit the SRSp within the time threshold, the WTRU may report 1440 to the LMF that the verification procedure cannot be completed. In some embodiments, if 1425 the WTRU determined or measured LOS indicator is above the threshold, transmission of the SRSp may not be needed or desired. In various embodiments, the WTRU may report 1450 measurements (e.g., RSRP), WTRU location and/or determined LOS indicator (based on the received PRS) associated with the target TRP to the network. It is contemplated that the embodiments disclosed herein may combine steps or features other embodiments, perform steps in any order or omit features or steps.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method for a wireless transmit receive unit (WTRU) comprising:
receiving, from a network, configuration information for line of sight (LOS) indicator verification including positioning reference signal (PRS) and sounding reference signal for positioning (SRSp) configurations, a threshold and an associated time window;
receiving, from the network, a request to verify a LOS indicator and a SRS resource ID associated with the SRSp configuration;
receiving, from a target transmit receive point (TRP), a PRS associated with the PRS configuration;
measuring one or more characteristics of the PRS and determining an associated LOS indicator;
comparing the associated LOS indicator to the configured threshold and determining the associated LOS indicator is below the configured threshold; and
transmitting a sounding reference signal for positioning (SRSp) associated with the SRS resource ID within the configured associated time window from receiving the PRS, in response to determining the associated LOS indicator is below the configured threshold.

2. The method of claim 1, further comprising:
reporting, to the network, the measured one or more characteristics and the associated LOS indicator.

3. The method of claim 1, further comprising:
reporting, to the network, a LOS verification procedure cannot be completed when the SRSp cannot be transmitted within the configured associated time window.

4. The method of claim 1, wherein if a difference between an indicated angle of departure (AoD) of the PRS and a measured angle of arrival (AoA) of the PRS is greater than a configured angle threshold, the SRSp is transmitted in a direction of an SRSp AoD indicated in the request to verify the LOS indicator.

5. The method of claim 1, wherein if a difference between an indicated angle of departure (AoD) of the PRS and a measured angle of arrival (AoA) of the PRS is lower than an angle threshold, the SRSp is transmitted in a direction of the measured AoA of the PRS.

6. The method of claim 2, wherein the reported associated LOS indicator comprises a hard or soft indicator.

7. The method of claim 2, wherein the reporting includes measurements of the received PRS, a WTRU location and the determined LOS indicator.

8. The method of claim 1, further comprising:
using one or more verified LOS indicators to train an artificial intelligence machine learning (AIML) model.

9. A wireless transmit receive unit (WTRU) comprising:
a transceiver and a processor communicatively coupled with the transceiver, the transceiver and processor configured to:
receive, from a network, configuration information for line of sight (LOS) indicator verification including positioning reference signal (PRS) and sounding reference signal for positioning (SRSp) configurations, a threshold and an associated time window;
receive, from the network, a request to verify a LOS indicator and a SRS resource ID associated with the SRSp configuration;
receive, from a target transmit receive point (TRP), a PRS associated with the PRS configuration;
measure one or more characteristics of the PRS and determine an associated LOS indicator;
compare the associated LOS indicator to the configured threshold and determine the associated LOS indicator is below the configured threshold; and
transmit a sounding reference signal for positioning (SRSp) associated with the SRS resource ID within the configured associated time window from receiving the PRS, in response to determining the associated LOS indicator is below the configured threshold.

10. The WTRU of claim 9, wherein the processor and transceiver are further configured to:
report, to the network, the one or more measured characteristics and the associated LOS indicator.

11. The WTRU of claim 9, wherein the processor and transceiver are further configured to:
report, to the network, a LOS verification procedure cannot be completed when the SRSp cannot be transmitted within the configured associated time window.

12. The WTRU of claim 9, wherein if a difference between an indicated angle of departure (AoD) of the PRS and a measured angle of arrival (AoA) of the PRS is greater than a configured angle threshold, the SRSp is transmitted in a direction of an SRSp AoD indicated in the request to verify the LOS indicator.

13. The WTRU of claim 9, wherein if a difference between an indicated angle of departure (AoD) of the PRS and a measured angle of arrival (AoA) of the PRS is lower than an angle threshold, the SRSp is transmitted in a direction of the measured AoA of the PRS.

14. The WTRU of claim 10, wherein the reported LOS indicator comprises a hard or soft indicator.

15. The WTRU of claim 10, wherein the reporting includes measurements of the received PRS, a WTRU location and the determined LOS indicator.

16. The WTRU of claim 9, further comprising:
using one or more verified LOS indicators to train an artificial intelligence machine learning (AIML) model.
